(19) United States
(12) Patent Application Publication
(10) Pub. No.: US 2025/0062675 A1
(43) Pub. Date: Feb. 20, 2025

(54) POWER SUPPLY AND POWER SUPPLY SYSTEM

(71) Applicant: CANON KABUSHIKI KAISHA, Tokyo (JP)

(72) Inventor: SATOSHI KITAI, Kanagawa (JP)

(21) Appl. No.: 18/798,447

(22) Filed: Aug. 8, 2024

(30) Foreign Application Priority Data
Aug. 14, 2023 (JP) 2023-131866

(51) Int. Cl. H02M 1/00; H02M 3/335

(52) U.S. Cl. CPC H02M 1/0032; H02M 3/33507

(57) ABSTRACT

An embodiment of the present invention is a power supply capable of switching between a power saving mode and a normal power mode, and includes: a first power supply line that is an output line of a DC power supply; a first control IC configured to constantly operate and control the first power supply line; a second control IC configured to operate in the normal power mode and not to operate in the power saving mode; and a transformer configured to output a voltage of the first power supply line and including an auxiliary winding used to generate power to be supplied to the first control IC and the second control IC. In a case of transition from the power saving mode to the normal power mode, a load current of the first power supply line increases before start of supply of power to the second control IC.

### BACKGROUND

### Field

The present disclosure relates to power saving of a switching power supply.

### Description of the Related Art

In recent years, an effort of reducing standby power of an electric device has been actively made due to an increase in awareness to environmental friendliness. A certain amount of power is consumed inside an AC/DC power supply used in an electronic device as a loss also in a standby period in which the electronic device itself is not operating, and this power includes power consumed in an auxiliary power supply for an operation of the AC/DC power supply.

FIG. 1 illustrates a configuration of a conventional, general AC/DC power supply. Power received from an AC power supply passes through an input filter 101, is then rectified to DC in a diode bridge rectifier 102, and smoothed by a capacitor. The power converted to DC is converted to pulse wave AC by high-speed switching of a switch element such as a MOSFET included in a control circuit 104, and this AC is sent to the primary side (input side) of a transformer 105. The power transmitted to the secondary side (output side) is rectified by a rectifying element such as a diode, smoothed by a secondary side capacitor, and outputted as DC power.

The transformer 105 is formed of a primary winding on the primary side and a secondary winding on the secondary side, and a voltage outputted on the secondary side is determined based on a ratio of the numbers of turns in the respective windings and an on-off ratio of the switch element. In this case, the voltage after rectification on the secondary side is monitored, and a feedback unit 110 feeds back this voltage to a control IC 103 configured to control the switch element such that the output voltage on the secondary side is maintained constant.

An auxiliary winding is arranged inside the transformer 105 in addition to the primary winding and the secondary winding, and the power is transmitted also to the auxiliary winding side in the case where the power is transmitted from the primary side to the secondary side of the transformer. The power transmitted to the auxiliary winding is rectified by a rectifying element and smoothed by a capacitor in a smoothing circuit 107, and an auxiliary power supply voltage is generated.

An upper limit of voltage that is can be inputted into the control IC 103 is determined for the power supply voltage of the control IC 103, and the auxiliary power supply voltage is dropped by a voltage dropper 106 before being inputted into the control IC 103 so as not to exceed the certain upper limit. Moreover, there is a case where the control IC 103 also internally includes a voltage dropper for dropping the voltage from the input voltage of the control IC 103 to a voltage used inside the control IC 103 to generate a necessary voltage. In the case where a difference between the input voltage and the output voltage of the voltage dropper 106 increases, power consumed in the voltage dropper 106 also increases, and this causes a decrease in power saving efficiency of the AC/DC power supply. As described above, the above AC/DC power supply has a problem of the increase in power consumed in the auxiliary power supply and the decrease in power saving efficiency of the AC/DC power supply.

In order to solve this problem, Japanese Patent Laid-Open No. 2014-50220 discloses a configuration in which a transformer equipped with two types of auxiliary windings is prepared, and a suitable auxiliary power supply voltage is selected as necessary from among two types of auxiliary power supply voltages that are a high voltage and a low voltage. A detection unit for each of the auxiliary power supply voltages is provided, and a voltage optimal as a power supply voltage necessary for a control IC is selectively used. In the case where the low auxiliary power supply voltage is lower than the power supply voltage necessary for the control IC, the high auxiliary power supply voltage is used. If not, the low auxiliary power supply voltage is used. This can restrict the voltage inputted into the control IC without passing of a voltage dropper.

As a configuration for achieving power saving, there is a configuration in which multiple control ICs (assumed to be a first control IC that constantly operates regardless of whether the power supply is in a power saving mode or a normal power mode in which power is not saved and a second control IC that operates only in the normal power mode) and a switching power supply are combined. In the power saving mode, only the circuit of the first control IC that supplies power for standby operates, and supplies the limited power for standby to the main control circuit. In such a configuration, power efficiency in the power saving mode needs to be improved by reducing circuit systems that operates during the power saving to minimum. Note that operating in the normal power mode is defined as a normal operation, and operating in the power saving mode is defined as a power saving operation.

An operation start voltage for staring a control operation of the power supply is generally defined for the control IC, and the control IC cannot start the operation unless a voltage exceeding the operation start voltage is inputted. In the case where a control IC voltage satisfying the operation start voltage that causes the first control IC to operate is determined in the above-mentioned configuration including the first control IC and the second control IC, a condition of the operation start voltage of the second control IC may not be satisfied due to voltage drop in power-on of the power supply to the second control IC.

Moreover, there is a case where the operation start voltage of the second control IC is originally higher than the operation start voltage of the first control IC. In this case, if the number of turns in the auxiliary winding is adjusted such that the auxiliary winding outputs the control IC voltage satisfying exactly the operation start voltage of the first control IC, the operation start voltage of the second control IC cannot be satisfied.

Accordingly, some kind of measure is necessary. For example, in the case where the number of turns in the auxiliary winding for outputting the control IC voltage satisfying the operation start voltages of both of the first control IC and the second control IC is set in advance, the control IC voltage higher than the minimum voltage necessary for the operation is outputted. Accordingly, power is wastefully consumed in a voltage dropper for adjusting the voltage that is higher than necessary, and this becomes a cause of the decrease in power saving efficiency.

If the control IC voltage generated from the auxiliary winding can be changed depending on the operation state of the power supply, the power consumed in the voltage dropper for the control IC voltage can be reduced. Using the method of Japanese Patent Laid-Open No. 2014-50220 allows the power supply to perform switching between the two types of auxiliary windings as necessary and select the auxiliary power supply voltage such that the condition of the operation voltage of each control IC is satisfied.

### SUMMARY

However, in the method of Japanese Patent Laid-Open No. 2014-50220, two types of auxiliary windings are prepared, and the design of the transformer is thus complicated. Moreover, since a circuit for switching and detection circuits for determining the conditions of switching are required, the added circuits are complicated, and the number of parts increases.

Alternatively, a configuration in which the control IC is directly controlled from the main body control circuit side connected to the AC/DC power supply and the main body control circuit causes the required auxiliary power supply voltage to be outputted at a required timing is conceivable. However, in this case, a device for insulation such as a photo-coupler is added to secure insulation between the main control circuit and the primary side of the AC/DC power supply, and a terminal for input from outside is provided on the control IC side. These addition, provision, and the like make the configuration complicated.

Accordingly, in view of the above problems, an object of the present disclosure is to reduce standby power in a power saving mode of an AC/DC power supply and improve power saving efficiency in a configuration that is simpler than a conventional configuration.

One embodiment of the present invention is a power supply capable of switching between a power saving mode and a normal power mode, the power supply including: a first power supply line that is an output line of a DC power supply; a first control IC configured to constantly operate and control the first power supply line; a second control IC configured to operate in the normal power mode and not to operate in the power saving mode; and a transformer configured to output a voltage of the first power supply line and including an auxiliary winding used to generate power to be supplied to the first control IC and the second control IC, and in a case of transition from the power saving mode to the normal power mode, a load current of the first power supply line increases before start of supply of power to the second control IC.

Further features of the present invention will become apparent from the following description of exemplary embodiments with reference to the attached drawings.

### BRIEF DESCRIPTION OF THE DRAWINGS

FIG. 1 is a block diagram illustrating a configuration of a conventional AC/DC power supply;

FIG. 2 is diagram showing the relationship of FIG. 2A and FIG. 2B and FIG. 2A and FIG. 2B collectively show a block diagram illustrating a configuration of a power supply system according to a first embodiment;

FIG. 3 is a timing chart in the case where power efficiency in a power saving mode decreases;

FIG. 4 is a timing chart in the case where the power efficiency in the power saving mode is improved by the first embodiment;

FIG. 5 is a block diagram extracting a circuit around a first transformer in an AC/DC power supply;

FIG. 6 is a block diagram illustrating a configuration of a main body control circuit according to the first embodiment;

FIG. 7 is a block diagram illustrating a configuration of an AC/DC power supply in a variation of the first embodiment;

FIG. 8 is a block diagram illustrating a configuration of an AC/DC power supply in a variation of the first embodiment; and

FIG. 9 is a block diagram illustrating a configuration of a power supply system according to a second embodiment.

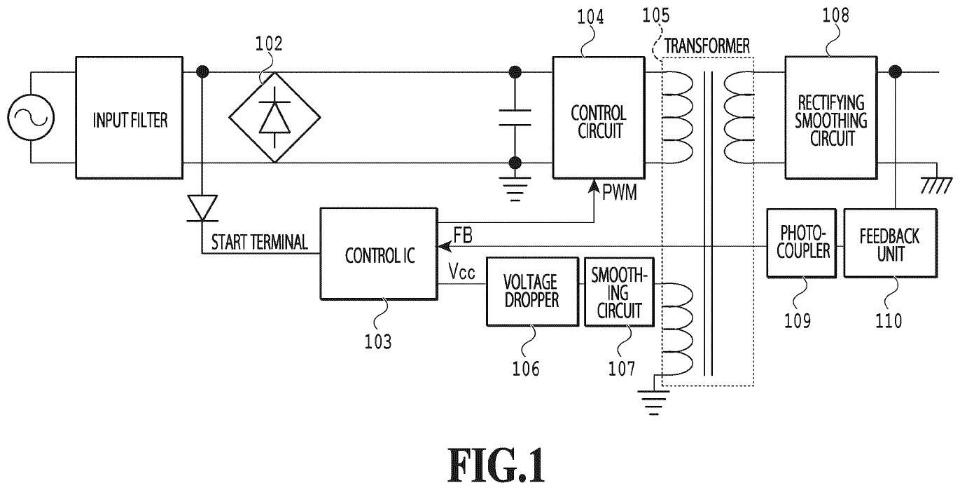

### DESCRIPTION OF THE EMBODIMENTS

### First Embodiment

### <Configuration of Power Supply System >

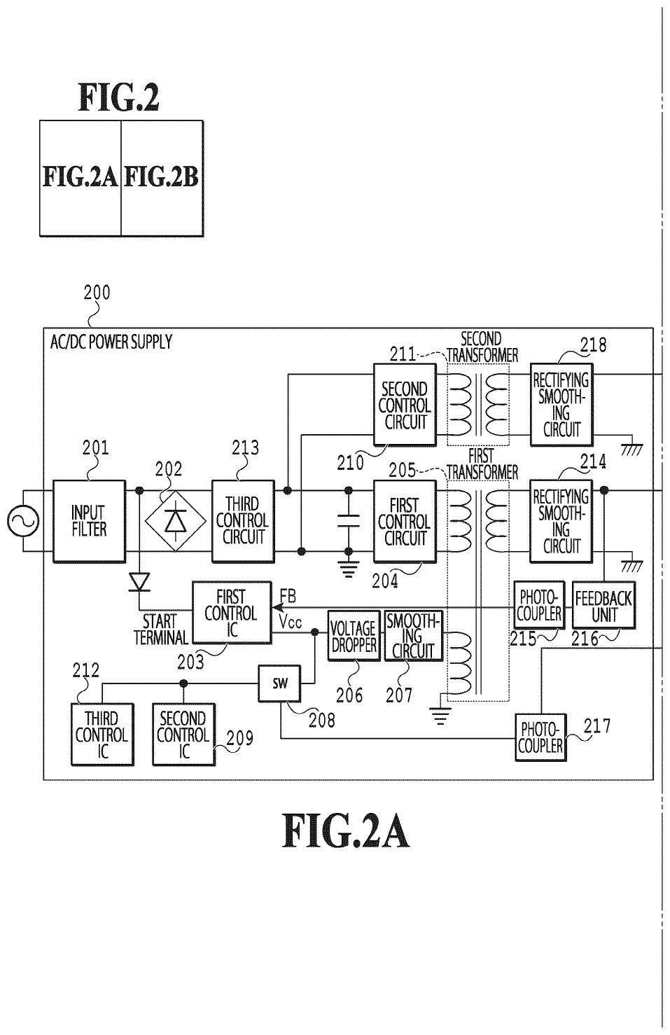

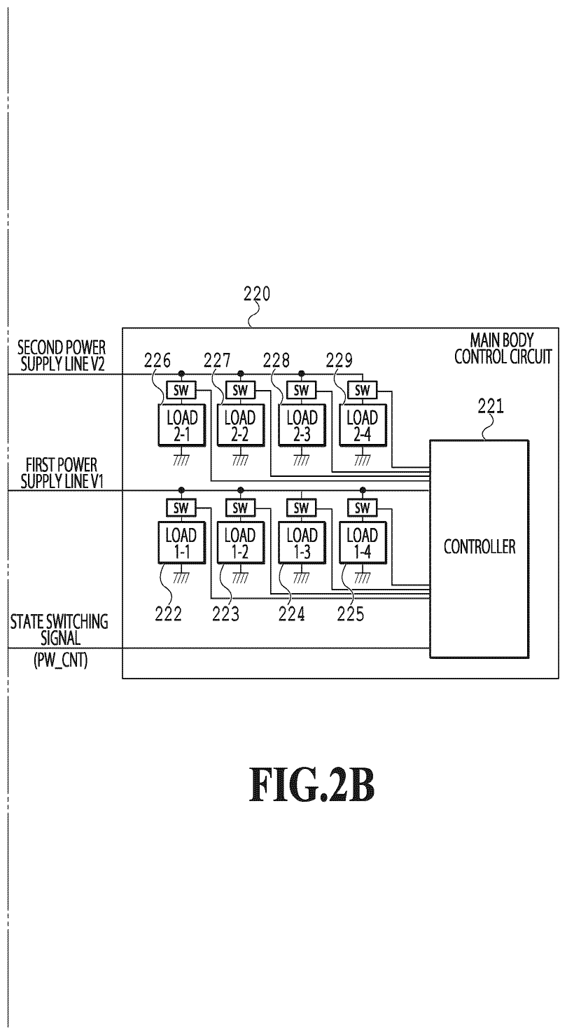

FIG. 2A and FIG. 2B show a block diagram illustrating a configuration of a power supply system according to the present embodiment. An AC/DC power supply 200 converts an AC power of an electric outlet to a DC power, and supplies the DC power supply to a main body control circuit 220. The number of DC power supply output lines in the AC/DC power supply is not limited to one, and the AC/DC power supply outputs two or more DC power supplies in some cases. The AC/DC power supply 200 in the present example includes a first power supply line V1 and a second power supply line V2 as the output lines.

Moreover, the AC/DC power supply 200 can be switched between a state where the AC/DC power supply 200 operates while saving power (referred to as power saving mode) and a state where the AC/DC power supply 200 operates while not saving power (that is, in normal power) (referred to as normal power mode), and has a reception function of receiving a state switching signal (PW_CNT) for switching the operation state.

The main body control circuit 220 operates by using powers supplied via the DC power supply output lines (first power supply line V1 and second power supply line V2), and achieves various functions. Moreover, the main body control circuit 220 has a function of controlling the state switching signal (PW_CNT) for switching the AC/DC power supply 200 between the power saving mode and the normal power mode.

First, a circuit configuration inside the AC/DC power supply 200 illustrated in FIG. 2A and FIG. 2B is explained.

In general terms, in a power supply, power received from an AC power supply passes through an input filter 201, is rectified to DC in a diode bridge rectifier 202, and is smoothed by a capacitor.

The power converted to DC is converted to pulse wave AC by high-speed switching of a semiconductor element such as a MOSFET included in a first control circuit 204, and this AC is sent to the primary side (input side) of a first transformer 205. Thereafter, the power transmitted to the secondary side (output side) of the first transformer 205 is rectified by a semiconductor element such as a diode included in a first rectifying smoothing circuit 214, is smoothed by a secondary side capacitor, and is outputted as DC power of the first power supply line V1.

Similarly, the power converted to DC is converted to pulse wave AC by high-speed switching of a semiconductor element such as a MOSFET included in a second control circuit 210, and this AC is sent to the primary side (input side) of a second transformer 211. Thereafter, the power transmitted to the secondary side (output side) of the second transformer 211 is rectified by a semiconductor element such as a diode included in a second rectifying smoothing circuit 218, is smoothed by a secondary side capacitor, and is outputted as DC power of the second power supply line V2.

### <Activation Sequence of First Control IC>

In the case where an AC voltage is inputted into the AC/DC power supply 200, the AC voltage is applied to a start terminal of a first control IC 203, and the first control IC 203 starts an operation of the first control circuit 204.

The first transformer 205 is formed of a primary winding on the primary side and a secondary winding on the secondary side as well as an auxiliary winding for supplying power to the first control IC 203, a second control IC 209, and a third control IC 212.

The first control circuit 204 including the MOSFET sends the pulse wave power to the first transformer 205 by high-speed switching.

The first transformer 205 transmits the power to the secondary winding on the secondary side, and also simultaneously transmits the power to the auxiliary winding.

The power transmitted to the auxiliary winding is rectified and smoothed, and then supplied as power for the control ICs. First, the first control IC 203 is activated by power from the AC voltage applied to the start terminal. In the case where the first control IC 203 sends the power to the first transformer 205, a voltage of the first power supply line V1 is outputted, and a voltage Vccic supplied from the auxiliary winding is also outputted. In this case, the power transmitted to the auxiliary winding is rectified by a rectifying element and is smoothed by a capacitor in a smoothing circuit 207, and the control IC voltage Vccic is generated. A switch 208 is a switching unit for switching supply and stop of power to the second control IC 209 and the third control IC 212.

In the case where the control IC voltage Vccic supplied from the auxiliary winding exceeds an operation start voltage (referred to as Vstart1) of the first control IC 203, the first control IC 203 operates by the power from the auxiliary winding instead of the power from the AC voltage.

### <Sequence of Switching Between Power Saving Mode and Normal Power Mode>

The state switching signal (PW_CNT) for switching the operating state of the AC/DC power supply 200 is such a signal that the AC/DC power supply 200 is the normal power mode in the case where this signal is at a high level, and the AC/DC power supply 200 is in the power saving mode in the case where this signal is at a low level. The state switching signal (PW_CNT) just after the input of the AC voltage into the AC/DC power supply 200 is at the low level, and the AC/DC power supply 200 is in the power saving mode. Hereinafter, the “high level” is abbreviated as “high” and the “low level” is abbreviated as “low” for simplification.

In the case where the AC/DC power supply 200 is transitioned from the power saving mode to the normal power mode in which no power is saved, the main body control circuit 220 changes the state switching signal (PW_CNT) from low to high. Then, the power of the control IC voltage Vccic supplied via the auxiliary winding is supplied to the second control IC 209 and the third control IC 212, and the second control IC 209 and the third control IC 212 start to operate.

The second control IC 209 and the third control IC 212 are not limited to use for specific functions. However, in the present embodiment, the second control IC 209 is an IC for controlling the second control circuit 210 that generates the second power supply line V2. Moreover, the third control IC 212 is a power factor correction (PFC) circuit that corrects a power factor of the AC/DC power supply 200. The second power supply line V2 and the power factor correction circuit are circuits that do not operate in the power saving mode, and operate only in the normal power mode.

<Switching from Power Saving Mode to Normal Power Mode>

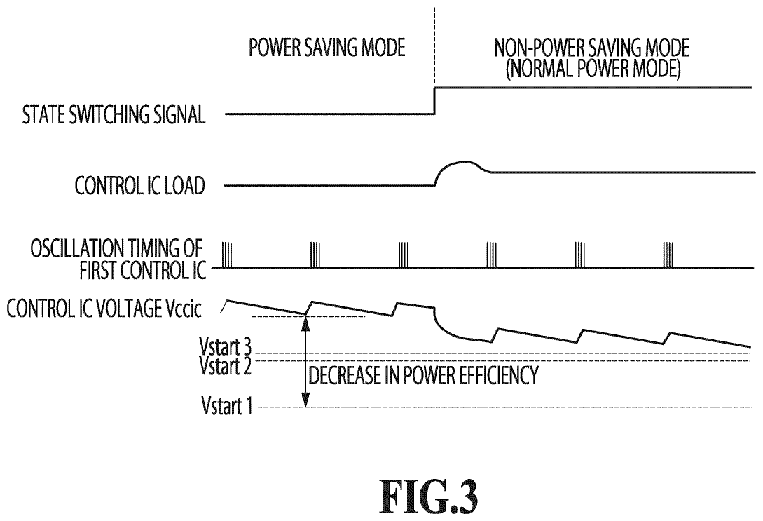

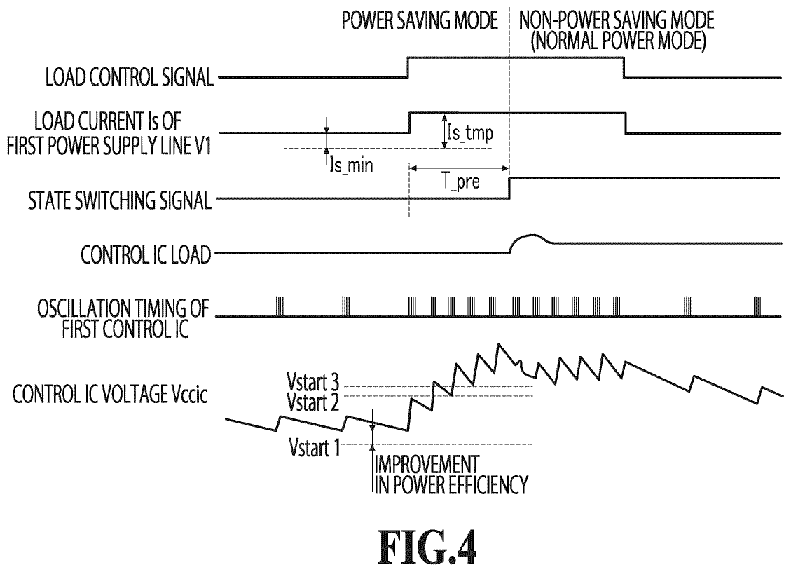

FIG. 3 is a timing chart illustrating the control IC voltage Vccic and an operation (oscillation) timing of the first control IC 203 in the case where the AC/DC power supply 200 switches from the power saving mode to the normal power mode. An oscillation cycle of the first control IC 203 changes depending on a current consumption of the first power supply line V1. In the power saving mode, the current consumption of the first power supply line V1 is suppressed to a low level. In the case where a load current of the first power supply line V1 is high, the oscillation cycle of the first control IC 203 is short. In the case where the load current is low, the oscillation cycle is long. In other words, the oscillation cycle of the first control IC 203 in Is=Is_tmp in FIG. 4 to be described later is different from that in Is=Is_min.

In the case where an operation start voltage (referred to as Vstart2) of the second control IC 209 is higher than the control IC voltage Vccic, the second control IC 209 cannot be activated even if the power is supplied to the second control IC 209. Similarly, in the case where an operation start voltage (referred to as Vstart3) of the third control IC 212 is higher than the control IC voltage Vccic, the third control IC 212 cannot be activated even if the power is supplied to the third control IC 212.

In order to activate the second control IC 209, the number of turns in the auxiliary winding in the first transformer needs to be adjusted and set such that the control IC voltage Vccic is higher than the operation start voltage Vstart2 of the second control IC 209. Similarly, in order to activate the third control IC 212, the number of turns in the auxiliary winding in the first transformer needs to be adjusted and set such that the control IC voltage Vccic is higher than the operation start voltage Vstart3 of the third control IC 212. For example, in the case where Vstart2=10 V and Vstart3=12 V, Vccic needs to be 12 V or higher. If Vccic=11 V, the second control IC can operate, but the third control IC cannot operate.

### <Decrease in Power Efficiency>

Specifically, in the case where the AC/DC power supply 200 is in the power saving mode, the control IC voltage Vccic only needs to be maintained at a voltage higher than the operation start voltage Vstart1. However, in order to switch the AC/DC power supply 200 to the normal power mode, the control IC voltage Vccic needs to be set to a voltage higher than both of the operation start voltage Vstart2 and the operation start voltage Vstart3. Accordingly, the number of turns in the auxiliary winding in the first transformer 205 needs to set larger than the number of turns necessary in the power saving mode.

For example, assume that the number of turns in the auxiliary winding in the first transformer 205 for setting the control IC voltage Vccic higher than the operation start voltage Vstart1 is 10, and the number of turns in the auxiliary winding in the first transformer 205 for setting the control IC voltage Vccic higher than the operation start voltage Vstart2 is 14. Under this assumption, the number of turns in the auxiliary winding in the first transformer 205 needs to be set to at least 14 or more.

However, setting an extra number of turns in the auxiliary winding has an adverse effect of a decrease in power efficiency in the power saving mode. In other words, the control IC voltage Vccic is maintained at a high voltage value also in the case where the AC/DC power supply 200 is in the power saving mode. Accordingly, power corresponding to a voltage difference between the operation start voltage Vstart1 of the first control IC 203 and the control IC voltage Vccic is consumed in a dropper circuit in the first control IC 203. Thus, the power efficiency in the power saving mode decreases.

### <Timing Chart for Improving Power Efficiency>

FIG. 4 is a timing chart illustrating the control IC voltage Vccic and the operation timing of the first control IC 203 in the case where the AC/DC power supply 200 switches from the power saving mode to the normal power mode in the present embodiment. As illustrated in FIG. 4, in the power saving mode after the operation start of the AC/DC power supply 200, a load current Is of the first power supply line V1 is low, and the oscillation cycle of the first control IC 203 is thus long. The number of turns in the auxiliary winding is set such that the control IC voltage Vccic in this case is higher than the operation start voltage Vstart1 of the first control IC 203. This number of turns in the auxiliary winding is assumed to be 10.

In the present embodiment, in the power saving mode, the control IC voltage Vccic is set to a voltage higher than the operation start voltage Vstart1 of the first control IC 203. Since this voltage is a minimum necessary voltage, this voltage contributes to an improvement in power efficiency of the AC/DC power supply 200 in the power saving mode.

However, since the control IC voltage Vccic in the power saving mode is lower than both of the operation start voltage Vstart2 and the operation start voltage Vstart3, the second control IC 209 and the third control IC 212 cannot be activated even if the state switching signal is changed to high.

Accordingly, in the present embodiment, an appropriate load is selected by using a load control signal used to control each of multiple loads, and the selected load is connected to the first power supply line V1 to increase the load current Is before the state switching signal is changed to high. In this case, the load current in the power saving mode is referred to as Is_min, and the temporarily-increased load current is referred to as Is_tmp. Increasing the load current Is shortens the oscillation cycle of the first control IC 203, and the control IC voltage Vccic can be increased. A load that generates the load current Is_tmp achieving a condition where Vccic>Vstart2 and Vccic>Vstart3 is selected. A certain time period is required for the control IC voltage Vccic to exceed both of the operation start voltage Vstart2 and the operation start voltage Vstart3, from the increase of the load current Is. In this case, a preparation time period T_pre is required. Note that, in a general power supply control IC, this required time period is, for example, about several tens of milliseconds to several hundreds of milliseconds.

After the load current Is_tmp is applied and the control IC voltage Vccic exceeds both of the operation start voltage Vstart2 and the operation start voltage Vstart3, the state switching signal is changed from low to high. The second control IC 209 and the third control IC 212 can be thereby activated. Since the load current Is_tmp is required only at the timing where the AC/DC power supply 200 transitions from the power saving mode to the normal power mode, the load current Is_tmp does not increase the power consumption in the power saving mode.

The control timings of the load control signal and the state switching signal are stored as a control program of a controller 221 in the main body control circuit 220 by defining the required preparation time period T_pre in advance by calculation, experiment, or the like.

### <Selection of Preparation Time Period T_Pre>

The higher the load current Is_tmp is, the shorter the preparation time period T pre is. Accordingly, it is preferable to prepare in advance the preparation time period T_pre necessary for each of load currents Is_tmp corresponding to the loads to be selected, and store the preparation time period T pre in a storage medium in the controller. The optimal preparation time period T pre corresponding to the selected load can be selected and used for control of the load control signal and the state switching signal.

### <Method of Determining Number of Turns in Auxiliary Winding and Load Current Is_tmp>

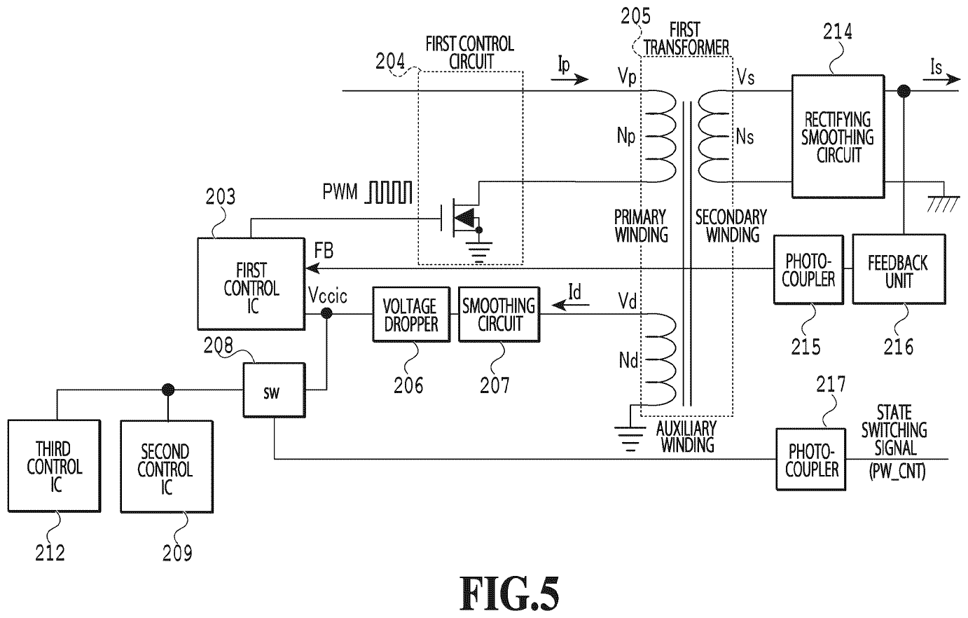

FIG. 5 is a block diagram extracting a circuit around the first transformer 205 in the AC/DC power supply illustrated in FIG. 2A and FIG. 2B.

The first transformer 205 is formed of the primary winding on the primary side and the secondary winding on the secondary side as well as the auxiliary winding for supplying power to the first control IC 203, the second control IC 209, and the third control IC 212. In the case where the first control IC 203 sends power to the primary winding of the first transformer 205, the voltage of the first power supply line V1 is outputted, and the voltage Vccic supplied from the auxiliary winding is also outputted. Since the voltage of the first power supply line V1 is transmitted from a feedback unit 216 to the first control IC 203 via a photo-coupler 215 to perform feedback control, the voltage of the first power supply line V1 is maintained constant irrespective of the magnitude of the load current. Meanwhile, since the voltage Vccic supplied from the auxiliary winding is not a target of the feedback control, the voltage fluctuates depending on the magnitude of the load current of the first power supply line V1.

The following relationships are established among the control IC voltage Vccic, the voltage Vd of the auxiliary winding, and the load current Is of the first power supply line V1.

$$( control IC voltage Vccic ) = ( Oscillation Frequency of First Control Circuit 204 ) \times ( Voltage Vd of Auxiliary Winding ) \qquad Formula ( 1 )$$

$$( Oscillation Frequency of First Control Circuit 204 ) = ( Coefficient ) \times ( Load Current Is of First Power supply line V 1 ) \qquad Formula ( 2 )$$

$$( Voltage Vd of Auxiliary Winding ) = ( Number Nd of Turns in Auxiliary Winding ) \text{} / ( Number Np of Turns in Primary Winding ) \times ( Voltage Vp of Primary Winding ) \qquad Formula ( 3 )$$

The control IC voltage Vccic is proportional to the oscillation frequency of the first control circuit 204 and the voltage Vd of the auxiliary winding. Moreover, the oscillation frequency of the first control circuit 204 is proportional to the load current Is of the first power supply line V1, and the voltage Vd of the auxiliary winding is proportional to the number Nd of turns in the auxiliary winding. Accordingly, the control IC voltage Vccic is proportional to the load current Is of the first power supply line V1 and the number Nd of turns in the auxiliary winding.

The number Nd of turns in the auxiliary winding is physically determined to one value. However, the load current Is of the first power supply line V1 changes depending on the load current of the load on the control circuit side connected to the first power supply line V1.

In the present embodiment, the load current Is_min of the first power supply line V1 and the number Nd of turns in the auxiliary winding are determined such that the control IC voltage Vccic exceeds the operation start voltage Vstart1 of the first control IC 203 in the power saving mode. Moreover, the load current Is_tmp of the first power supply line V1 at which the control IC voltage Vccic exceeds both of the operation start voltage Vstart2 of the second control IC 209 and the operation start voltage Vstart3 of the third control IC 212 is determined.

In the present embodiment, the load current of the first power supply line V1 is increased from Is_min to Is_tmp by using the load control signal, before the state switching signal is changed to high. The load selectively used in this case is one or more loads among multiple loads present on the main body control circuit 220, and connecting the one or more loads increases the load current Is of the first power supply line V1. After the increase of the load current, the state switching signal is changed to high after elapse of the preparation time period T_pre taken for the voltage level of the control IC voltage Vccic to increase.

### <Details of Main Body Control Circuit>

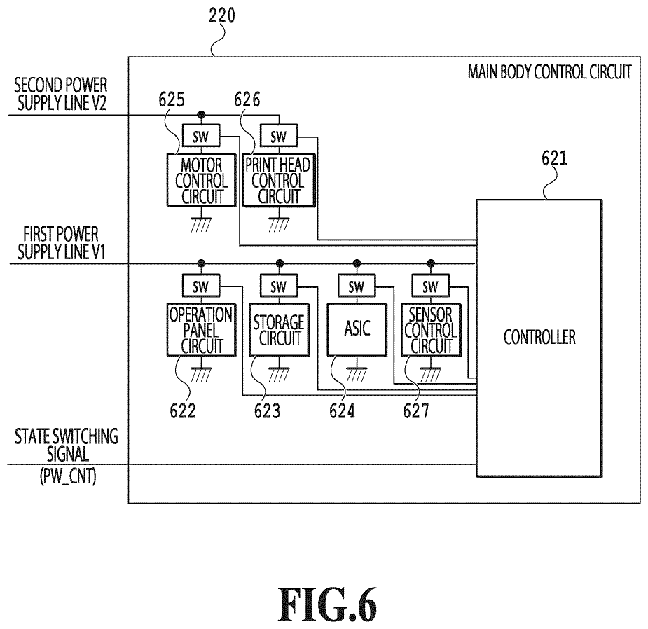

The main body control circuit 220 in the power supply system illustrated in FIG. 2A and FIG. 2B is explained below by using FIG. 6. A controller such as a microcomputer is mounted on the main body control circuit 220, and can operate by using the power of the first power supply line V1. The loads on the main body control circuit 220 are connected to the first power supply line V1 via a switch device such as an FET or a load switch, and the controller can connect the first power supply line V1 and the loads to each other by controlling the switch device.

FIG. 6 is a block diagram illustrating a specific configuration example inside the main body control circuit 220. Although explanation is given herein assuming that the main body control circuit is a controller board that causes the inkjet printer to operate, this is merely an example.

The loads on the main body control circuit 220 that are connected to the first power supply line V1 include, for example, an operation panel circuit 622, a storage circuit 623, an ASIC 624, a sensor control circuit 627, and the like. Moreover, loads such as a motor control circuit 625, a print head control circuit 626, and the like are connected to the second power supply line V2. A controller 621 connected to the first power supply line V1 on the main body control circuit 220 can control whether or not to supply the power to the loads connected to the first power supply line V1 and the loads connected to the second power supply line V2.

### <Selection of Load>

Control relating to load selection by the controller 621 mounted on the main body control circuit 220 is explained. The controller 621 generates a load current corresponding to Is_tmp by, for example, connecting the operation panel circuit 622 to the first power supply line V1 as the load to increase the voltage level of Vccic, and then performs control of changing the state switching signal from low to high. In this case, the load current generated by connecting the operation panel circuit 622 needs to exceed Is_tmp, and needs to be lower than a maximum current Is_max that is the maximum current suppliable by the first control circuit 204 in the case where the AC/DC power supply 200 is in the power saving mode. Note that the load current may be generated by using a specific one load, or by using multiple loads. Specifically, in the present example illustrated in FIG. 6, one load or a combination of multiple loads may be used as long as the loads are the loads connected to the first power supply line V1. The load of the operation panel circuit may be used to cover the load current corresponding to Is_tmp, or the loads of the operation panel circuit and the storage circuit may be used. The loads of the operation panel circuit, the storage circuit, the ASIC, and the like are originally loads necessary in the normal power mode. However, a resistance load in accordance with the necessary amount of Is_tmp may be separately prepared as a circuit for generating the load current of Is_tmp according to the present embodiment.

### <Control Method of Load Selection>

There are multiple causes of transition from the power saving mode to the normal power mode (hereinafter, this state transition is referred to as “recovery”). The control method may be changed such that, in such recovery, a load desired to promptly operate according to a function of the main body control circuit 220 is preferentially used as the load corresponding to Is_tmp. For example, in the case where the AC/DC power supply 200 transitions from the power saving mode to the normal power mode with a key operation by the user being a trigger, the operation panel circuit 622 is used as the load corresponding to Is_tmp to perform display of the operation panel as promptly as possible. Moreover, for example, in the case where the AC/DC power supply 200 transitions from the power saving mode to the normal power mode with reception of print data from an information processing apparatus (PC) being the trigger, the storage circuit 623 configured to receive the print data is used as the load corresponding to Is_tmp. An operation of receiving the print data can be thereby promptly started.

### Examples of Specific Roles of Respective ICs

In the present embodiment, for example, the following roles are conceivable as roles of the first control IC, the second control IC, and the third control IC.

The first control IC is a control IC that generates the voltages of the first power supply line and the auxiliary winding, and may be a power supply control IC that uses any of control methods of a flyback method, a forward method, an LLC method, and the like.

The second control IC is a control IC for the second power supply line, and may be a power supply control IC that uses any of control methods of the flyback method, the forward method, the LLC method, and the like. In order to improve power efficiency in the power saving operation of the AC/DC power supply, the second control IC is configured to suppress wasteful power consumption by not operating in the power saving operation of the AC/DC power supply.

The third control IC is a control IC for controlling a power factor correction circuit arranged subsequent to a diode bridge. The third control IC is a circuit necessary in the case where the first power supply line and the second power supply line output relatively large power in the normal operation, and does not operate in the case where the AC/DC power supply itself is in the power saving operation.

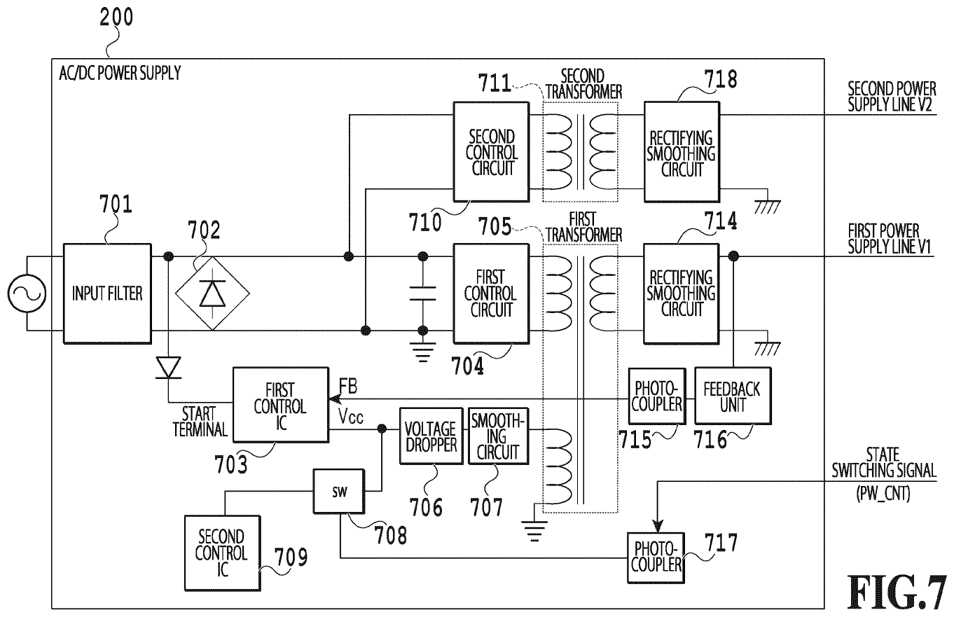

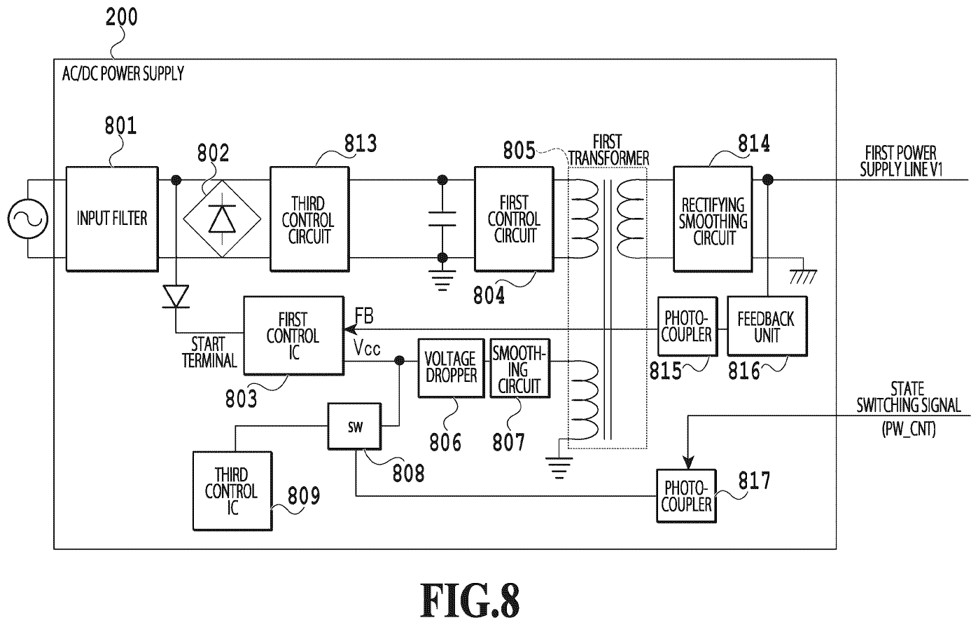

FIGS. 7 and 8 are each a block diagram illustrating a configuration of the AC/DC power supply 200 according to the first embodiment that has a different form from the AC/DC power supply 200 described above (see FIG. 2A and FIG. 2B). The point that the first control IC constantly operates and the second control IC and the third control IC operate only in the normal power mode is the same as described above. However, the roles and types of the control ICs are not limited to particular roles and types, and each of FIGS. 7 and 8 illustrate a variation of the first embodiment.

Specifically, as illustrated in FIG. 7, the AC/DC power supply 200 may be an AC/DC power supply formed of two control ICs of a flyback-type first control IC 703 and an LLC-type second control IC 709. Alternatively, as illustrated in FIG. 8, the AC/DC power supply 200 may be an AC/DC power supply formed of two control ICs of a flyback-type first control IC 803 and a third control IC 809 that is a power factor correction (PFC) circuit.

### Second Embodiment

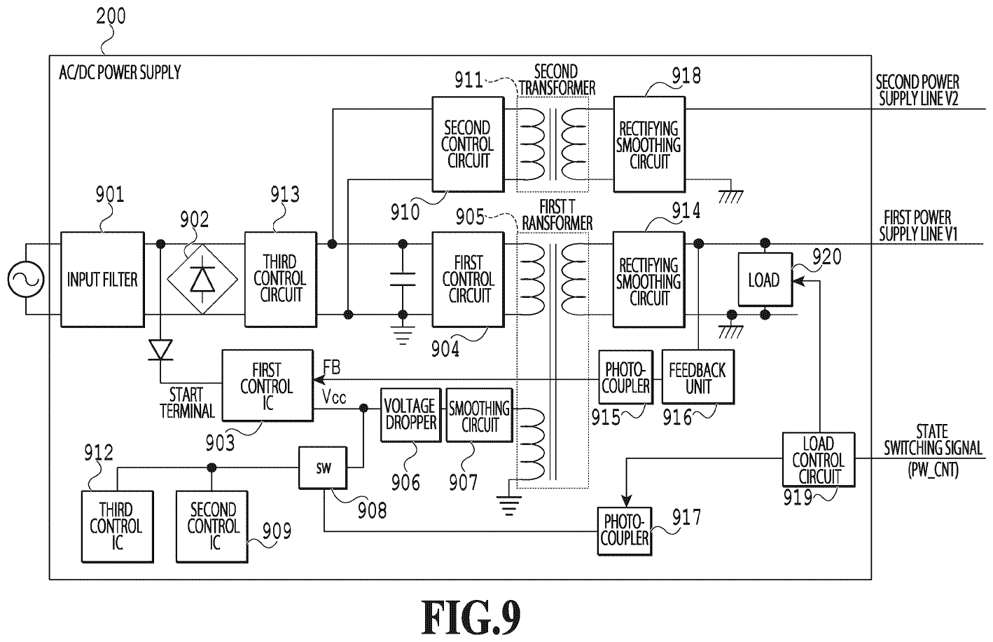

FIG. 9 is a block diagram illustrating a configuration of the AC/DC power supply 200 according to the present embodiment. The AC/DC power supply 200 according to the present embodiment is different from the first embodiment (see FIG. 2A and FIG. 2B) in that the AC/DC power supply 200 according to the present embodiment includes a load control circuit 919 and a load 920.

In the case where the state switching signal inputted into the AC/DC power supply 200 is changed from low to high, the state switching signal is inputted into the load control circuit in the AC/DC power supply 200, and the load control circuit supplies power to the load connected to the first power supply line V1 in the AC/DC power supply 200. This load is, for example, a load such as a resistance for generating the load current corresponding to Is_tmp. After a predetermined time period elapses from the generation of Is_tmp, the load control circuit supplies power based on the control IC voltage Vccic to a second control circuit 911 and a third control circuit 913.

In the present embodiment, the controller on the main body control circuit 220 connected to the AC/DC power supply 200 can change control of the state switching signal from low to high and transition the AC/DC power supply 200 from the power saving mode to the normal power mode without regard to generation of Is_tmp.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to reduce standby power in the power saving mode of the AC/DC power supply and improve power saving efficiency in a configuration that is simpler than a conventional configuration.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-131866, filed Aug. 14, 2023, which is hereby incorporated by reference wherein in its entirety.

What is claimed is:

1. A power supply capable of switching between a power saving mode and a normal power mode, the power supply comprising:
a first power supply line that is an output line of a DC power supply;
a first control IC configured to constantly operate and control the first power supply line;
a second control IC configured to operate in the normal power mode and not to operate in the power saving mode; and
a transformer configured to output a voltage of the first power supply line and including an auxiliary winding used to generate power to be supplied to the first control IC and the second control IC, wherein
in a case of transition from the power saving mode to the normal power mode, a load current of the first power supply line increases before start of supply of power to the second control IC.

2. The power supply according to claim 1, further comprising
a smoothing circuit configured to generate a control IC voltage by smoothing power transmitted to the auxiliary winding; and
a switching unit configured to perform switching of whether or not to supply power to the second control IC.

3. The power supply according to claim 2, wherein the number of turns in the auxiliary winding is set such that the control IC voltage in the power saving mode is higher than an operation start voltage of the first control IC.

4. The power supply according to claim 3, wherein the number of turns in the auxiliary winding is set such that the control IC voltage in the normal power mode is higher than an operation start voltage of the second control IC.

5. The power supply according to claim 1, further comprising a load and a load control circuit, wherein
the load control circuit increases the load current by connecting the load to the first power supply line.

6. The power supply according to claim 1, further comprising a receiving unit configured to receive a switching signal used to perform the switching between the power saving mode and the normal power mode.

7. A power supply system comprising:
a power supply according to claim 6; and
a control circuit connected to the power supply.

8. The power supply system according to claim 7, wherein the control circuit includes
a controller configured to control connection of a load to the first power supply line,
a plurality of the loads, and
a transmission unit configured to transmit the switching signal to the power supply.

9. The power supply system according to claim 8, wherein the controller increases the load current by connecting the load to the first power supply line.

10. The power supply system according to claim 8, wherein the higher the load current of the first power supply line is, the shorter a time period from a first timing at which the load current of the first power supply line is increased to a second timing at which the power supply transitions from the power saving mode to the normal power mode is.

11. The power supply system according to claim 10, wherein
there are a plurality of causes of transition from the power saving mode to the normal power mode, and
the load connected to the first power supply line is selected from among the plurality of loads depending on a type of the cause.

12. The power supply system according to claim 11, wherein the controller connects the load selected from among the plurality of loads to the first power supply line, and changes the switching signal to be transmitted to the power supply from a low level to a high level after the time period elapses.
